(19) United States
(12) Patent Application Publication
(10) Pub. No.: US 2006/0214876 A1
(43) Pub. Date: Sep. 28, 2006

(54) Electronic device having a light bus for controlling light emitting elements

(75) Inventors: Magnus Jendbro, Staffanstorp (SE); Thomas Ekdahl, Sodra Sandby (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 11/087,270

(22) Filed: Mar. 23, 2005

(51) Int. Cl. G09G 3/14

(52) U.S. Cl. 345/46

(57) ABSTRACT

An apparatus for driving a plurality of light emitting diodes (LEDs) includes a general purpose input/output (GPIO) for outputting a control signal. The apparatus further includes a plurality of LED packages via a shared control bus to the GPIO. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### BACKGROUND OF THE INVENTION

1. Technical Field

The present invention relates generally to electronic devices and, more particularly, but not by way of limitation, to a method and apparatus for driving light emitting elements such as light emitting diodes (LEDs).

2. History of Related Art

Light emitting diodes (LEDs) are solid-state devices that produce light by passing an electronic current across layers of semiconductor chips. The semiconductor chips are typically housed in a reflector, which in turn is encased in an epoxy lens. LEDs may be used not only as display elements, but may also be used, for example, as backlight sources of a liquid crystal display (LCD). The number of LEDs used depends on the form of the display and the amount of light required for the display. The relatively small size, high brightness, and wide viewing angle of the LEDs make them ideal for use in electronic devices, such as mobile phones and personal digital assistants (PDAs).

With the advent of colored LEDs, the use of LEDs in color displays has increased. Colored LEDs currently dominate the sign market and are making inroads into the traffic signal market. Separate red, green, and blue LEDs can be combined to produce many colors and intensities of light, such as, for example, white light for backlighting displays. Colored LEDs have shown significant promise for automobile lighting and are being sold in a variety of consumer products, such as flashlights and wands. In commercial applications, colored LEDs, which can be combined in custom arrays, can be controlled to produce dynamic color-changing effects for, for example, contour lighting, accent lighting, signage, advertising, or display applications.

Another application of colored LEDs is in mobile phones. Current mobile phones have not only reduced dimensions, but also often have different appearances. Some mobile phones use LEDs to emit light for various purposes, such as, for example, to indicate received signals. One reason to use LEDs in mobile phones is to reduce the combined cost and size of the phones by, for example, having the LED and other components of the mobile phone share the same housing, power supply, and application specific integrated circuit (ASIC). However, in existing mobile phones where LEDs are utilized, the LEDs and other components of the mobile phone often share little functionality; thus, the LEDs often require a separate ASIC for controlling the LEDs. For example, in many cases, the LEDs are controlled via a general purpose input output (GPIO) port. Each LED or LED group requires at least one control pin from the GPIO port. Since each LED or LED group requires at least one control pin from the GPIO port, a plurality of GPIO ports may be needed to power the LEDs, which results in an increase in the cost and size of the mobile phone.

### SUMMARY OF THE INVENTION

An apparatus for driving a plurality of light emitting diodes (LEDs) includes a general purpose input/output (GPIO) for outputting a control signal. The apparatus further includes a plurality of LED packages connected via a shared control bus to the GPIO.

At least one of the plurality of LED packages may include programming logic circuitry. The programming logic circuitry may include address decode circuitry, data decode circuitry, a data latch, and a plurality of Pulse Width Modulation/Digital-to-Analog converters. The address decode circuitry may be adapted to receive the control signal via the shared bus while the data latch may be adapted to generate and store power control data based upon the control signal. The control data may include an n-bit address pattern followed by an m-bit data pattern and n and m may be positive integers. The n-bit address pattern may include an address for a particular LED package of the plurality of LED packages, while the m-bit address pattern may include information to control at least one of an intensity and a brightness of the particular LED package. The plurality of LED packages may be connected in parallel on the shared control bus. The control signal may include address information corresponding to a particular LED package of the plurality of LED packages. The control signal may be used to selectively control at least one of the LED packages and may include data used to control at least one of LED-package brightness.

A method of driving at least one of a plurality of light emitting diodes (LEDs) includes outputting a control signal from a general purpose input/output (GPIO) to a plurality of LED packages connected to the GPIO via a shared control bus. The method further includes selectively operating at least one of the plurality of LED packages responsive to information contained in the control signal.

At least one of the plurality of LED packages may include programming logic circuitry. The programming logic circuitry may include address decode circuitry, data decode circuitry, a data latch, and a plurality of Pulse Width Modulation/Digital-to-Analog converters. The address decode circuitry may be adapted to receive the control signal via the shared bus while the data latch may be adapted to generate and store power control data based upon the control signal. The control data may include an n-bit address pattern followed by an m-bit data pattern and n and m may be positive integers. The n-bit address pattern may include an address for a particular LED package of the plurality of LED packages, while the m-bit address pattern may include information to control at least one of an intensity and a brightness of the particular LED package. The plurality of LED packages may be connected in parallel on the shared control bus. The control signal may include address information corresponding to a particular LED package of the plurality of LED packages. The control signal may be used to selectively control at least one of the LED packages and may include data used to control at least one of LED-package brightness.

An article of manufacture for driving at least one of a plurality of light emitting diodes (LEDs), including at least one computer readable medium and processor instructions contained on the at least one computer readable medium. The processor instructions configured to be readable from the at least one computer readable medium by at least one processor causing the at least one processor to operate as to output a control signal from a general purpose input/output (GPIO) to a plurality of LED packages connected to the GPIO via a shared control bus and selectively operating at least one of the plurality of LED packages responsive to information contained in the control signal.

A method of assigning an address to at least one light emitting diode (LED) includes mounting at least one LED package on a circuit board. The method further includes exposing at least one of the at least one LED package to light. Responsive to the step of exposing, the at least one exposed LED package entering an address programming mode. The method further includes receiving, by the at least one exposed LED package, of a control signal, the control signal comprising address information corresponding to the at least one exposed LED package.

### BRIEF DESCRIPTION OF THE DRAWINGS

A more complete understanding of the present invention may be obtained by reference to the following Detailed Description of Illustrative Embodiments of the Invention, when taken in conjunction with the accompanying Drawings, wherein:

FIG. 1 is a circuit diagram of a display device and a drive device;

FIG. 2 is a block diagram of an LED package;

FIG. 3 is a block diagram of a plurality of LED packages connected to a single general purpose input/output (GPIO);

FIG. 4 is a timing diagram of an address data sequence for controlling an LED;

FIG. 5 is an LED programming state diagram; and

FIG. 6 is a flow diagram illustrating assignment of an address to a plurality of LEDs after mounting on a circuit board.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

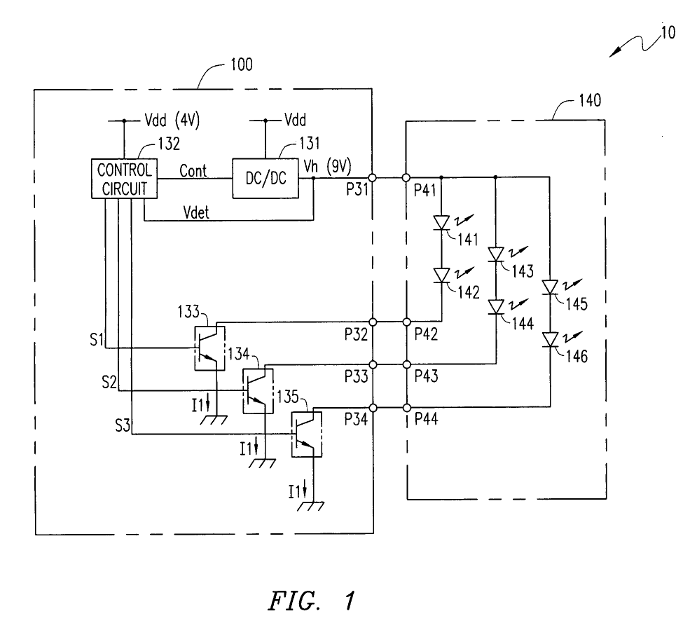

FIG. 1 is a diagram of a circuit 10 for use with an electronic apparatus such as, for example, a mobile phone. The circuit 10 includes a display device 140 and a drive device 100 for driving the display device 140. The display device 140 has three groups of two serially connected LEDs 141 and 142 (the group referred to as a first light emitting element series), two serially connected LEDs 143 and 144 (the group referred to as a second light emitting element series), and two serially connected LEDs 145 and 146 (the group referred to as a third light emitting element series). The number of light emitting element series and the LEDs in the respective light emitting element series are given merely for illustration. The number and configurations of the series and LEDs can be determined by design criteria as needed.

The drive device 100 includes a step-up type switching power supply circuit 131 for stepping up a power supply voltage Vdd (e.g., 4V) of, for example, a lithium battery to a greater step-up voltage Vh. The step-up voltage Vh is applied to the LEDs 141-146 through a pin P31 of the drive device 100 and a pin P41 of the display device 140.

Since LEDs are constant-current elements, drivers 133-135 are usually implemented as constant-current drivers. Each of the constant-current drivers 133-135 provides a constant current I1 when turned ON, irrespective of the number of LEDs in a series, and shuts down current through the LEDs when turned OFF. The constant-current drivers 133-135 are respectively turned ON and OFF in accordance with respective instructions S1-S3 in order to control the associated LEDs 141-146 of the display device 140. The ON/OFF process requires a control signal for powering each group of serially-connected LEDs and therefore results in extra circuitry.

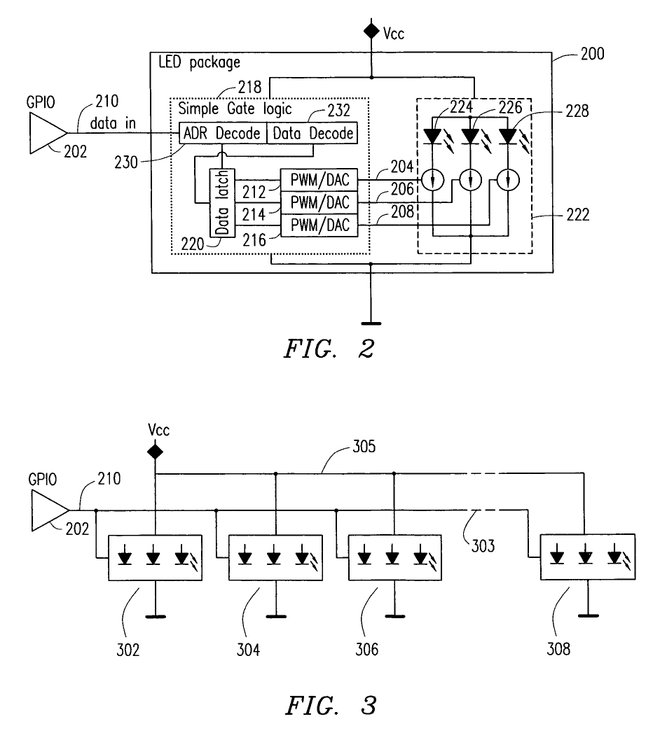

FIG. 2 is a block diagram of an LED package 200 controlled by a general purpose input/output (GPIO) 202. LEDs 224, 226, and 228 may be, for example, different-colored LEDs within the LED package 200 and contained under a plastic lens housing. A control signal 210 generated by the GPIO 202 is delivered to logic circuitry 218. The logic circuitry 218 includes address decoding circuitry 230, data decoding circuitry 232, a data latch 220, and Pulse Width Modulation devices or Digital-to-Analog converters (PWM/DACs) 212, 214, and 216. The data latch 220 acts as a memory for storing data to control, for example, light intensity levels of the LEDs 224, 226, and 228.

Based upon the control signal, power control data may be generated by the data latch 220 and output to one or more of the PWM/DACs 212, 214, and 216. The PWM/DACs 212, 214, and 216 control the intensity of the LEDs 224, 226, and 228, respectively. A pulse width or a DAC output level, as appropriate, of the PWM/DACs 212, 214, and 216 is controlled so as to independently control a brightness of each of the LEDs 224, 226, and 228, respectively, thereby controlling the intensity of light emitted by each of the LEDs 224, 226, and 228.

By controlling the relative intensity of each of the LEDs 224, 226, and 228, a color “palette” is created, enabling a user to control the combined color and intensity of light emitted by the LED package 200 as if the light were emitted by a single LED. Thus, the user can control the color of the light emitted by the LED package 200 as, for example, a parameter of a display mode setting for a particular display mode option.

FIG. 3 is a block diagram of a plurality of LED packages 302, 304, 306, and 308 connected to a signal from the general purpose input/output (GPIO) 202. The control signal 210 from the GPIO 202 is sent on a shared control bus 303 that each of the LED packages 302, 304, 306, and 308 is connected to. A shared power bus 305 powers all of the LED packages 302, 304, 306, and 308. The shared control bus 303 feature illustrated in FIG. 3 may be used to minimize a need for GPIO 202 ports. The arrangement shown in FIG. 3 may also be used to provide flexibility of adding additional LED packages to the shared control bus 303.

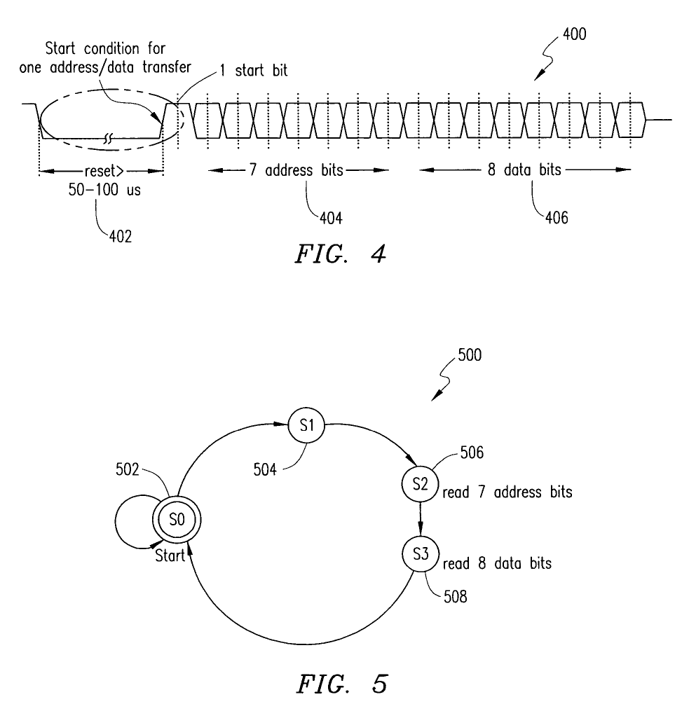

FIG. 4 is a timing diagram 400 of an address data sequence for controlling an LED. The timing diagram 400 includes a 7-bit address pattern 404 followed by an 8-bit data pattern 406. The 7-bit address pattern 404 includes an address for a specific LED of a plurality of LEDs connected to, for example, the shared control bus 303. The address pattern 404 points to a specific LED in order to program the specific LED. The 7-bit address pattern 404 is followed by the 8-bit data pattern 406, which includes control information related, for example, to the brightness and color of the specific LED. For example, to brighten the LED from a nominal brightness level, the 8-bit data pattern 406 may be loaded with a bit pattern to represent a longer period of time, thereby increasing the LED duty cycle (i.e., “on” period) and the corresponding average power delivered to the LED. A PWM power signal generated via the data pattern 406 causes the LED to illuminate with a brighter intensity. To reduce the brightness of the LED, the 8-bit data pattern 406 may be loaded with a bit pattern to represent a shorter period of time, reducing the corresponding average power delivered to the LED. The rate at which the LED is turned on and the rate at which the LED is turned off may be adjusted by varying the value placed in the 8-bit data pattern 406.

FIG. 4 further illustrates a reset condition 402 represented by an illustrative time interval of 50-100 μs, which is the approximate amount of time required in various embodiments to reset the shared control bus 303 such that a new address or a new command is loaded into the shared control bus 303. The shared control bus 303 may be used to provide programming instructions to a specific LED of a plurality of LEDs.

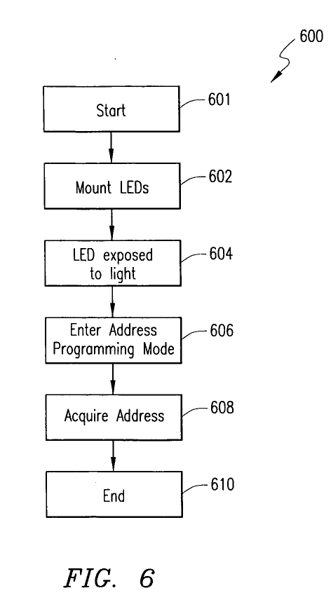

FIG. 5 is an LED programming state diagram 500. The state diagram 500 is initially in a wait/reset state 502. In response to a reset pulse, the state diagram 500 enters a state 504, in which state the LED waits for a start bit to be received. Once the start bit is received, a state 506 is entered, at which state the 7-bit address pattern is read. The 7-bit address pattern includes the address for a specific LED of a plurality of LEDs connected, for example, to the shared control bus 303. After reading the 7-bit address pattern at the state 506, the state diagram 500 enters a state 508, where the 8-bit data pattern is read. The 8-bit data pattern includes control information related, for example, to the brightness and color of the specific LED. After programming, the state diagram 500 returns to the state 502.

A problem associated with addressable LEDs is that each individual LED requires a separate address. Assigning an address for each individual LED may create difficulties in tracking the address of each LED during and after a process of placing the LEDs on a printed circuit board (PCB).

According to various embodiments of the invention, an address is assigned to a specific LED or a plurality of LEDs after the LED or plurality of LEDs is mounted on the PCB. Assigning an address to a specific LED provides flexibility in mounting LEDs without having to track an address of each of the LEDs. This technique to assign a speicfic address to an LED or plurality of LEDs after mounting on a PCB may also be used on other components whose position on the PCB is important, such as, for example, various sensors.

FIG. 6 is a flow diagram 600 illustrating assignment of an address to a plurality of LEDs after mounting on a PCB. The flow 600 starts at step 601. At step 602, an LED package is mounted on the PCB. At step 604, the LED package is exposed to light, utilizing the reciprocal function that an LED produces a current when exposed to light. At step 606, the LED package, after detecting the light, enters into an address programming mode. At step 608, the LED package receives a control signal (e.g., the control signal 210 sent on the shared control bus 303) and acquires an address. The process 600 ends at step 610. The process 600 may be applied to a plurality of LED packages simultaneously so that the plurality of LED packages can all be programmed with the same address by performing the process 600 once. The process 600 is typically a one-time operation. In such as case, after an LED package has acquired an address, that particular LED package can no longer enter the address programming mode.

Embodiments of the present invention may be implemented in, for example, hardware, software (e.g., carried out by a processor that executes computer-readable instructions), or a combination thereof. The computer-readable instructions may be program code loaded in a memory such as, for example, Random Access Memory (RAM), or from a storage medium such as, for example, Read Only Memory (ROM). For example, a processor may be operative to execute software adapted to perform a series of steps in accordance with principles of the present invention. The software may be adapted to reside upon a computer-readable medium such as, for example, a magnetic disc within a disc drive unit. The computer-readable medium may also include a flash memory card, EEROM based memory, bubble memory storage, ROM storage, etc. The software adapted to perform according to principles of the present invention may also reside, in whole or in part, in static or dynamic main memories or in firmware within a processor (e.g., within microcontroller, microprocessor, or a microcomputer internal memory).

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof. The previous Detailed Description is of embodiment(s) of the invention. The scope of the invention should not necessarily be limited by this Description. The scope of the invention is instead defined by the following claims and the equivalents thereof.

What is claimed is:

1. An apparatus for driving a plurality of light emitting diodes (LEDs), the apparatus comprising:
a general purpose input/output (GPIO) for outputting a control signal; and
a plurality of LED packages connected via a shared control bus to the GPIO.

2. The apparatus of claim 1, wherein at least one of the plurality of LED packages comprises programming logic circuitry.

3. The apparatus of claim 2, wherein the programming logic circuitry comprises:
address decode circuitry;
data decode circuitry;
a data latch; and
a plurality of Pulse Width Modulation/Digital-to-Analog converters.

4. The apparatus of claim 3, wherein the address decode circuitry is adapted to receive the control signal via the shared bus.

5. The apparatus of claim 4, wherein the data latch is adapted to generate and store power control data based upon the control signal.

6. The apparatus of claim 5, wherein:
the control data comprises an n-bit address pattern followed by an m-bit data pattern; and
n and m are positive integers.

7. The apparatus of claim 6, wherein the n-bit address pattern comprises an address for a particular LED package of the plurality of LED packages.

8. The apparatus of claim 7, wherein the m-bit data pattern includes information to control at least one of an intensity and a brightness of the particular LED package.

9. The apparatus of claim 1, wherein the plurality of LED packages are connected in parallel on the shared control bus.

10. The apparatus of claim 1, wherein the control signal is used to selectively control at least one of the LED packages.

11. The apparatus of claim 1, wherein the control signal comprises address information corresponding to a particular LED package of the plurality of LED packages.

12. The apparatus of claim 1, wherein the control signal comprises data used to control at least one of LED-package brightness.

13. A method of driving at least one of a plurality of light emitting diodes (LEDs), the method comprising:
outputting a control signal from a general purpose input/output (GPIO) to a plurality of LED packages connected to the GPIO via a shared control bus; and
selectively operating at least one of the plurality of LED packages responsive to information contained in the control signal.

14. The method of claim 13, wherein at least one of the plurality of LED packages comprises programming logic circuitry.

15. The method of claim 14, wherein the logic circuitry comprises:
address decode circuitry;
data decode circuitry;
a data latch; and
a plurality of Pulse Width Modulation/Digital-to-Analog converters.

16. The method of claim 15, wherein the address decode circuitry is adapted to receive the control signal via the shared control bus.

17. The method of claim 16, wherein the data latch is adapted to generate and store power control data responsive to the control signal.

18. The method of claim 17:
wherein the control data comprises a n-bit address pattern followed by a m-bit data pattern; and
n and m are positive integers.

19. The method of claim 18, wherein the n-bit address pattern comprises an address of a particular LED package of the plurality of LED packages.

20. The method of claim 19, wherein the m-bit data pattern includes information to control at least one of an intensity and a brightness of the particular LED package.

21. The method of claim 13, wherein the plurality of LED packages are connected in parallel to the shared control bus.

22. The method of claim 13, wherein the control signal is used to selectively control at least one of the LED packages.

23. The method of claim 13, wherein the control signal comprises address information corresponding to a particular LED package of the plurality of LED packages.

24. The method of claim 13, wherein the control signal comprises data used to control at least one of LED package brightness.

25. An article of manufacture for driving at least one of a plurality of light emitting diodes (LEDs), the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
output a control signal from a general purpose input/output (GPIO) to a plurality of LED packages connected to the GPIO via a shared control bus; and
selectively operate at least one of the plurality of LED packages responsive to information contained in the control signal.

26. A method of assigning an address to at least one light emitting diode (LED), the method comprising:
mounting at least one LED package on a circuit board;
exposing at least one of the at least one LED package to light;
responsive to the step of exposing, the at least one exposed LED package entering an address programming mode;
receiving, by the at least one exposed LED package, of a control signal;
wherein the control signal comprises address information corresponding to the at least one exposed LED package.
